(19) United States
(12) Patent Application Publication
(10) Pub. No.: US 2005/0237583 A1
(43) Pub. Date: Oct. 27, 2005

(54) Apparatus and method for differentiating size of scanned document

(76) Inventors: Ya-Hui Chang, Taoyuan (TW); Kai-Yao Chen, Taoyuan (TW)

Correspondence Address: Richard P. Berg, ESQ.;c/o LADAS & PARRY, Suite 2100, 5670 Wilshire Boulevard, Los Angeles, CA, 90036-5679, US

(21) Appl. No.: 11/101,173

(22) Filed: Apr. 6, 2005

(30) Foreign Application Priority Data
Apr. 7, 2004 (TW) 093109660

(51) Int. Cl. H04N 1/04

(52) U.S. Cl. 358/474

(57) ABSTRACT

The invention relates to a judgment apparatus for determining the size of a document. The judgment apparatus includes an automatic document feeding (ADF) with a scan window, a scanner carriage, and a decision module. The ADF transmits the document. The scanner carriage determines a first dimension of the scan window masked by the document, and outputs the first size. The decision module determines the size of the document according to the first dimension output by the scanner carriage.

### BACKGROUND OF THE INVENTION

1. Field of the Invention

A present invention relates to a judgment apparatus and particularly to the apparatus for determining the size of a document.

2. Description of the Prior Art

In typical scanners of the prior art, the corresponding driver must allocate memory to store the image to be scanned in the application program before the start of scanning. As for the size of the memory, it depends on the document to be scanned.

In the prior art, reflective or transparent scanners require the user to choose the size of the document to be scanned, or the document can be previewed, so as to perform auto crop by the corresponding driver. Because documents have a fixed ratio between the length and the width, while automatically cropping, the width of the document can be gauged from its length, and then its size can be determined.

In the prior art, a typical scanner with an automatic document feeding knows the size of the document before scanning; the size can also be chosen by the user or determined by the method of preview. If previewing is used, one more row of sensors is needed in order to detect the document. Thus, the cost of production is also higher due to the requirement of many sensors.

### SUMMARY OF THE INVENTION

Accordingly, an objective of the present invention is to provide a judgment apparatus and methods for differentiating the size of a document, so as to save the use of hardware components of sensors and to reduce cost of production.

The judgment apparatus of the present invention comprises an automatic document feeding (ADF), a scanner carriage, a decision module, a controller, and a memory device.

The ADF with a scan window including a default pattern is used to transmit a document. The scanner carriage is for determining a first dimension of the scan window being masked by the document and for outputting the first dimension. The decision module determines the size of the document based upon the first dimension outputted by the scan carriage.

The judgment apparatus further comprises a controller for moving the scanning carriage to a first position, thus allowing the scanning carriage to determine the first dimension of the scan window being masked by the document under a predetermined resolution at the first position. The decision module determines the size of the document based upon the first dimension outputted by the scanner carriage and a default condition.

The controller further moves the scanner carriage to a second position; the scanner carriage scans the content of the document according to the size of the document determined by the decision module at the second position, and then it outputs a scanning outcome.

The judgment apparatus of the present invention determines the size of the document by a firmware without needing additional hardware sensors; it also does not need the complex circuit of the method with hardware that includes many sensors. Therefore, the present invention cuts down the prime cost and scants hardware components.

The advantage and spirit of the invention may be understood by the following recitations together with the appended drawings.

### BRIEF DESCRIPTION OF THE APPENDED DRAWINGS

FIG. 1 is a block diagram of the judgment apparatus of the present invention.

FIG. 2 is a diagram showing that the judgment apparatus of FIG. 1 differentiating and scanning a document.

FIG. 3 is a diagram showing the default pattern and the scan window of the judgment apparatus of FIG. 1

FIG. 4 is a flow chart showing the method of determining the size of a document by the present invention.

### DETAILED DESCRIPTION OF THE INVENTION

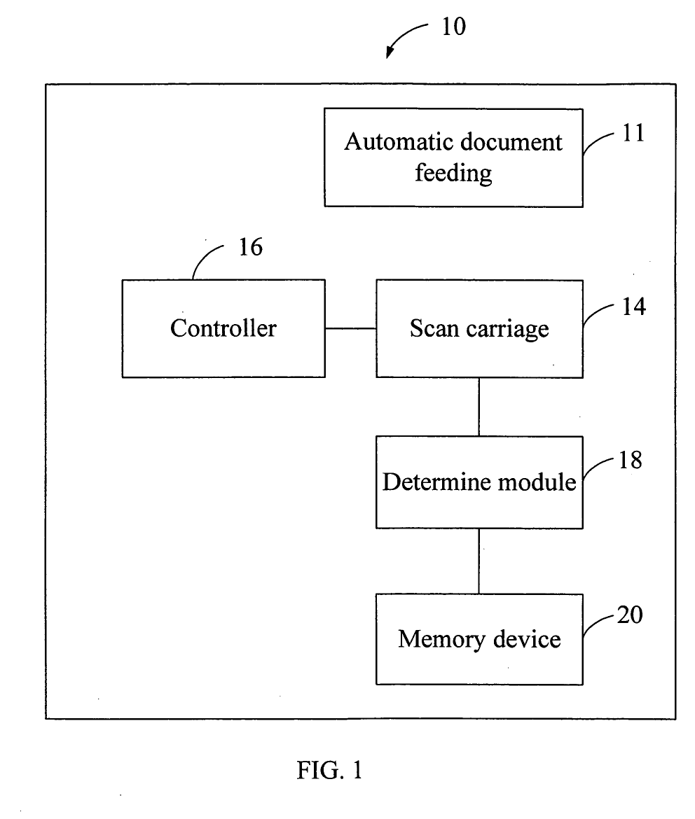

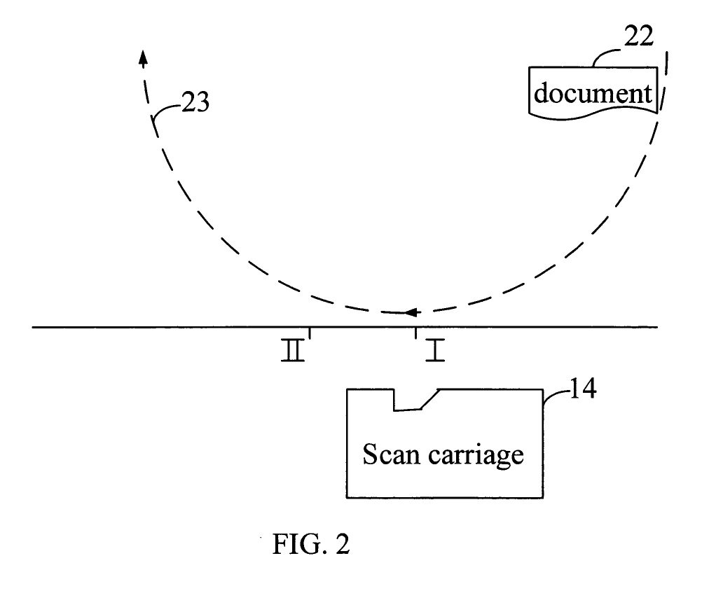

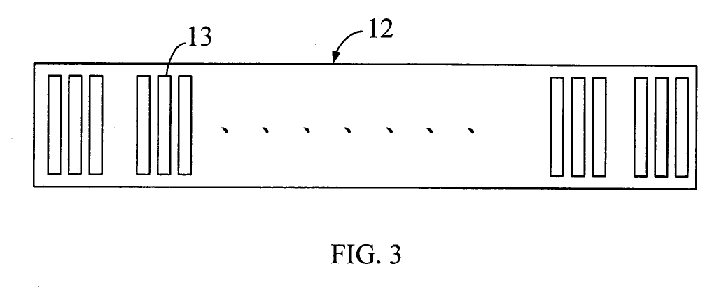

Referring to FIG. 1 through FIG. 3, FIG. 1 is a block diagram showing the judgment apparatus 10 of the present invention; FIG. 2 is a diagram showing the judgment apparatus 10 of FIG. 1 differentiating and scanning a document 22; FIG. 3 is a diagram of the scan window 12 of the judgment apparatus 10 of FIG. 1 and the default pattern 13. The judgment apparatus 10 of the present invention is used for determining the size of the document 22. The judgment apparatus 10 comprises an automatic document feeding 11, a scanner carriage 14, a decision module 18, a controller 16, and a memory device 20.

The automatic document feeding 11 is used to transmit the document 22. The curve in the FIG. 2 represents the track of feed-in track 23 of the automatic document feeding 11. The automatic document feeding 11 comprises a scan window 12 that includes a default pattern 13, as shown in FIG. 3. The scanner carriage 14 both determines the dimension of the scan window 12 being masked by the document 22 to output the first dimension and scans the content of the document 22 in order to output a scanning outcome. Because the scan window 12 includes the default pattern 13, the first dimension of the document can be determined based upon the condition of the default pattern 13 being masked by the document 22. The decision module 18 determines the size of the document 22 according to the first dimension that the scanner carriage 14 outputted. The controller 16 is used to move the scanner carriage 14, and the memory device is used to store the scanning outcome.

As shown in FIG. 2, the controller 16 moves the scanner carriage 14 to the first position I. The scanner carriage scans the first dimension of the scan window 12 being masked by the document 22 under a predetermined resolution and outputs the first dimension at the first position I. In an embodiment, the default resolution is the lowest one so that the scanning outcome can be derived in the shortest time because the lowest resolution requires the shortest time. In another embodiment, the scanner carriage 14 uses less analytic time to determine the first dimension of the scan window 12 being masked by the document 22 because of scanning the document 22 through a binary mode.

The decision module 18 determines the size of the document 22 according to a default condition and the first dimension which the scan carriage 14 outputted. Since there is a fixed ratio of its length and width in general documents 22, the judgment apparatus 10 of the present invention only needs to determine the first dimension of the document 22 in order to gauge the size of the document 22 through the fixed ratio.

As shown in FIG. 2, the controller 16 can move the scanner carriage 14 to the second position II, and then the scanner carriage 14 scans the content of the document 22 at the position II and outputs a scanning outcome according to the size of the document 22 determined by the decision module 18. The scanning outcome can be stored in the memory device 20.

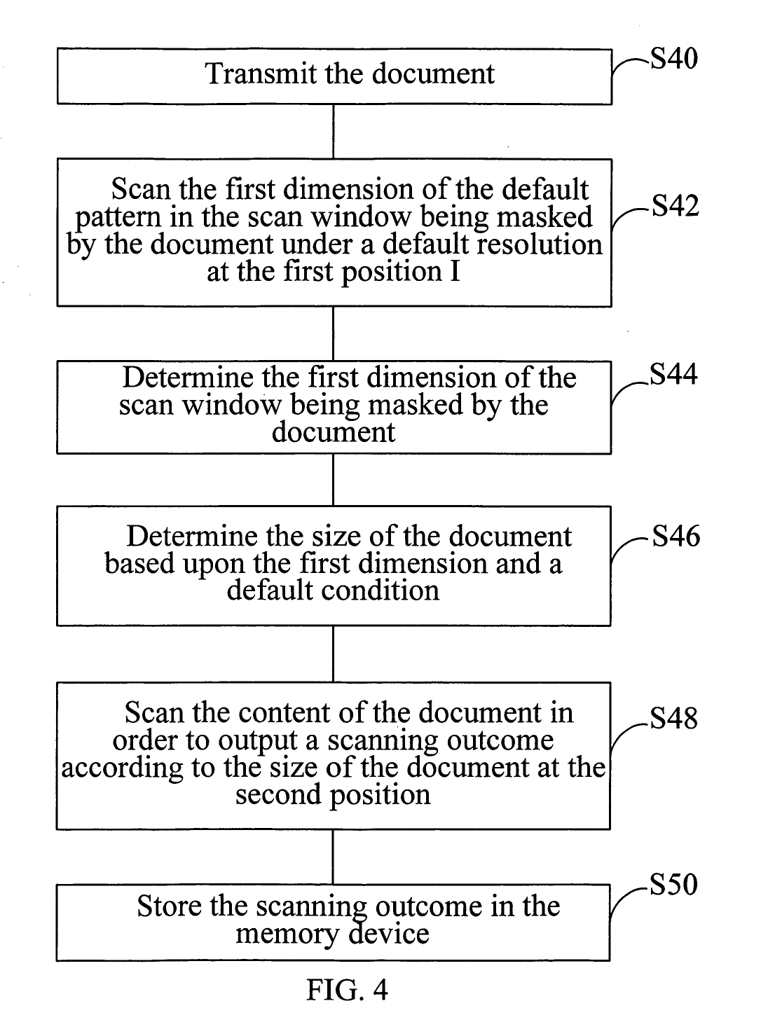

Please refer to FIG. 4. FIG. 4 is a flow chart showing the method of determining the size of the document 22 in the present invention. The present invention also provides another method for determining the size of the document. With reference to FIG. 1 through FIG. 3, the method of the present invention to determine the size of document 22 is explained. The method of the present invention to determine the size and to scan the document 22 comprises the following steps:
S40: Transmit the document 22;
S42: Scan the first dimension of the default pattern 13 in the scan window 12 being masked by the document 22 under a default resolution at the first position I;
S44: Determine the first dimension of the scan window 12 being masked by the document 22;
S46: Determine the size of the document 22 based upon the first dimension and a default condition
S48: Scan the content of the document 22 in order to output a scanning outcome according to the size of the document 22 at the second position; and
S50: Store the scanning outcome in the memory device 20.

As for the default resolution in the step S42, it can employ a resolution lower than a regular resolution to scan the first dimension of the scan window 12 being masked by the document 22. As for the default condition in the step S46, it can employ the fixed ratio of length and width of the document 22 to determine the size of the document 22.

Compared with techniques of the prior art, the judgment apparatus and the method of the present invention for determining the size of a document uses the method of firmware to determine the size of the document without having to use additional hardware sensors; it also does not need the complex circuitry of the method of hardware with many sensors. Therefore the present invention economizes the use of hardware parts, and cuts down the cost.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A judgment apparatus for determining the size of a document, the judgment apparatus comprising:
an automatic document feeding for transmitting the document, the automatic document feeding including a scan window;
a scanner carriage for determining a first dimension of the scan window masked by the document and outputting the first dimension; and
a decision module for determining the size of the document according to the first dimension outputted by the scanner carriage.

2. The judgment apparatus of claim 1, wherein the first dimension is the width of the scan window masked by the document.

3. The judgment apparatus of claim 2, wherein the scan window includes a default pattern, and the first dimension is determined by the default pattern covered by the document.

4. The judgment apparatus of claim 1, wherein the judgment apparatus further comprises a controller for moving the document to a first position, in order to determine the first dimension by the scanner carriage.

5. The judgment apparatus of claim 4, wherein the scanner carriage scans the document under a predetermined resolution to determine the first dimension.

6. The judgment apparatus of claim 5, wherein the predetermined resolution is lower than a regular resolution to scan the content of the document.

7. The judgment apparatus of claim 4, wherein the controller further moves the scanner carriage to a second position, and the scanner carriage scans the content of the document at the second position, outputting a scanning outcome based on the size of the document determined by the decision module.

8. The judgment apparatus of claim 7, wherein the judgment apparatus further comprises a memory device for storing the scanning outcome.

9. The judgment apparatus of claim 1, wherein the decision module determines the size of the document based upon the first size outputted by the scan carriage and a default condition.

10. A method for determining the size of a document, comprising the steps of:
(a) transmitting the document;
(b) scanning the document at a first position in order to determine a first dimension of a scan window masked by the document;
(c) determining the size of the document according to the first dimension.

11. The judgment method of claim 10, wherein the first dimension is the width of the scan window masked by the document.

12. The judgment method of claim 10, wherein the scan window includes a default pattern.

13. The judgment method of claim 10, wherein step (b) scans the first dimension of the document under a predetermined resolution.

14. The judgment method of claim 13, wherein the predetermined resolution is lower than a regular resolution.

15. The judgment method of claim 10, wherein step (c) determines the size of the document based on the first dimension and a default condition.

16. The judgment method of claim 10, wherein the method further comprises:
(d) scanning the content of the document at the second position in order to output a scanning outcome based on the size of the document.

17. The judgment method of claim 16, wherein the method further comprises:
(e) storing the scanning outcome.
